(19) United States
(12) Patent Application Publication
(10) Pub. No.: US 2011/0265185 A1
(43) Pub. Date: Oct. 27, 2011

(54) METHOD ENABLING A USER TO KEEP PERMANENTLY THEIR FAVOURITE MEDIA FILES

(75) Inventors: Robert John Lewis, London (GB); Philip Sant, London (GB); Christopher John Evans, London (GB); James White, London (GB); Stephen Pocock, Egham (GB); Lucien Rawden, London (GB); Alexander Gordon, London (GB)

(73) Assignee: Omnifone Limited, London (GB)

(21) Appl. No.: 13/062,532

(22) PCT Filed: Sep. 10, 2009
(86) PCT No.: PCT/GB2009/051167

§ 371 Date: Jul. 8, 2011

(30) Foreign Application Priority Data
Sep. 10, 2008 (GB) 0816551.6
Sep. 24, 2008 (GB) 0817460.9
Nov. 11, 2008 (GB) 0820593.2

(51) Int. Cl. G06F 21/00

(52) U.S. Cl. 726/26

(57) ABSTRACT

This invention enables a user to convert their favourite DRM protected media files, which would otherwise have significant use restrictions, to media files that can be played without limitation of time. This is especially useful where the DRM protected files are supplied as part of a subscription service and the ability to playback those files ends when the subscription ends. This approach relies on the ability to gather playback metrics for the DRM protected media files, to analyse them to determine the user's favourites, and then to provide the user with non-time limited versions of those favourite digital media files. In one implementation, a user's favourite music tracks can still be played, even though a music subscription service has ended.

### BACKGROUND OF THE INVENTION

1. Field of the Invention

This invention relates to a method of providing digital media content to computing devices; the digital media content is DRM (digital rights management) protected. The method enables a user to keep that content permanently.

2. Description of the Prior Art

Historically, consumers have had only one legal option for downloading digital media files, specifically that those media files would be tied to a small number of devices, typically between one and three, with the selection of device types also restricted according to their capabilities and the consumer's purchased media unable to be played on any of that consumer's other media playing devices.

Such Digital Rights Management (DRM) protection has been essential to ensure that the Rights Holders of the digital media content are protected, and hence that royalties may be paid to them in accordance with the relevant copyright law.

However, DRM has also met with increasing consumer resistance over time, as consumers replace older media playing devices and find that the DRM licenses previously purchased do not permit playback on their new devices, due to the aforementioned limitations. To some extent, DRM technologies have been enhanced or reworked to solve some of these difficulties. However, the major problem of consumer resistance remains.

The present invention seeks to resolve this issue by providing, in one implementation, a mechanism whereby digital media tracks which are provided within a DRM-protected environment, such as an AYCE (“All You Can Eat”) music subscription service model, are used to provide the consumer with permanent access to their preferred digital media content without limitation of time and/or without being tied to a specific set of playback devices, both as a reward for the consumer and as a mechanism by which resistance to DRM may be overcome.

### BRIEF SUMMARY OF THE INVENTION

The invention is a method of providing digital media content to computing devices, including the steps:
(a) gathering playback metrics for a user's DRM-protected digital media files;
(b) analysing those playback metrics to determine a user's favourite media files; and
(c) providing the user with non-time limited versions of those favourite digital media files.

Using this method, it is possible, in one implementation, to in effect convert the user's favourite DRM protected media files, which would otherwise have significant use restrictions, to media files that can be played without limitation of time (for example, played back an unlimited number of times, without time limit). This is especially useful where the DRM protected files are supplied as part of a subscription service and the ability to playback those files ordinarily ends when the subscription ends. With this invention, the user's favourite files can still be played, even though the subscription ends.

The owners of the rights (usually copyrights) in the media files can still be compensated appropriately because a media file that is played by a user triggers a payment to the copyright holder each time the file is played; but if the track is played more than a certain number of times, then the rights holder can treat themselves as fully compensated for that track and hence can permit that track to be listened to for ever without further payment. This approach relies however on the ability to gather playback metrics for the DRM protected media files, to analyse them to determine the user's favourites, and then to provide the user with non-time limited versions of those favourite digital media files.

Implementation features may include one or more of the following:

The playback metrics can measure the following to enable the selection of the non-time limited versions: how many times digital media content files are played back for more than a predefined threshold; or how often digital media content files are played back for more than a predefined threshold.

The user can choose the desired non-time limited versions (e.g. choose their favourites) from a list automatically generated by analysing the playback metrics. For example, the playback metrics may detect specific flags or notifications a user has applied to indicate that a track is a favourite track and that a non-time limited version of that track should be made available

The non-time limited versions can also be selected entirely automatically—e.g. without the user manually selecting their favourites.

The playback metrics can be analysed at a remote server or at the device, or a combination of the two. Analysis can be performed in different, customisable ways, for example to refine the accuracy of how favourites are selected.

The playback metrics that are analysed can relate to a single computing device that is used by the user, or to multiple computing devices that are used by the user. For the latter, the playback metrics for multiple computing devices can be aggregated together. The computing devices can be any computing device able to consume digital media files, they can therefore be any of the following: mobile telephone; PC, MP3 player, mobile device, in-car stereo, web browser, television set or any other digital media playback device.

The non-time-limited versions can be tied to one or more specific playback devices. Alternatively, the non-time-limited versions could be used on any playback device.

The non-time limited versions can be obtained by altering the DRM-protected digital media files already resident on the device. This can be done by the user accessing a tool that removes or modifies the DRM protection applied to the media file to make it non time-limited.

Instead of altering the DRM-protected digital media files already resident on the device, the non-time limited versions can be different files entirely. For example, they could be obtained from a remote web server.

The non-time limited versions can be DRM-protected but associated with a long term access rights object. This enables more complex behaviour to be allowed; for example, where we have a music subscription service, then the non-time limited version of a song could have the following attributes:
Can be played an unlimited number of times.
Can be synchronised an unlimited number of times with an unlimited number of players.
Can be burnt to CD up to a defined number of times.
Can be played after the subscription has expired.

Alternatively, the non-time limited versions could be not DRM-protected at all (‘DRM free’).

In the main implementation, the DRM-protected media files are supplied as part of an unlimited download music subscription service. When the subscription ends, the non-time limited versions can still be obtained and played back. A fixed number of non-time limited versions can be provided for each month of a DRM-based subscription service: for example, a fixed number of non-time limited music tracks can be provided each month - perhaps the user's favourite 10 tracks.

### BRIEF DESCRIPTION OF THE DRAWINGS

FIG. 1 shows the process logic for the Web Locker (see below).

FIG. 2 shows the KYF (see below) Rights Object Delivery.

FIG. 3 illustrates the process of clearing previous Rights Objects from a device which has been de-registered.

### DETAILED DESCRIPTION OF THE INVENTION

The present invention is implemented in a system called Keep Your Favourites™ (KYF). This is a system for providing users with free or bonus digital media content based on the content which is played the most by each individual user, that determination being based on the user's listening behaviour as garnered through metering data records captured from the user's device.

The first step is to perform the normal metering data collection from the user's devices. Details of one approach to metering can be found in PCT/GB2009/051091, the contents of which are incorporated by reference; details are provided also at Appendix 1. Next, the KYF allocation is reviewed, as is data in the user's subscription record to identify all of the user's devices and to award the user with free long term access to their most accessed/listened to content.

The KYF content is provided by sending long term access rights object (ROs) to the device and/or to also provide the user with access to a web-based locker where the user can access and download DRM free content.

If the user has not had enough plays to allow the system to choose the pre-configured number of top tracks for them, then the system may select as many tracks as possible from the user's metering data but if there are still outstanding tracks/media objects to award then it may in addition select from the top accessed/played/viewed media assets/content on the service as a whole and use that list to generate the awards.

The metering data from all of the user's registered devices—PC, mobile devices, MP3 players, in-car stereo, and so forth—are, in the preferred embodiment, aggregated together into a central set of playing data records where the device is merely a piece of channel metadata—allowing the records of all plays/accesses to be held together and reviewed/queried/examined irrespective of the actual device/channel that was used to access the media.

The technical issues resolved by the present invention involve the use of media playing metrics to identify a users most played music tracks, video games, videos or other digital media files; the aggregation of the playing metrics across disparate playback devices; and the provision of equivalent digital media files to which access is not limited by time, whether the media files are protected by DRM mechanism or mechanisms or not and whether that provisioning is performed by modifying the original digital media files or Rights Objects, providing new media files or a combination of both.

This implementation of the present invention is therefore a mechanism to legally supply digital media files to computing devices in such a manner as to permit the users of those devices to play the media files without limitation of time, while ensuring that the rights holders of the media files are compensated appropriately and that the media files supplied are those which the users have chosen to play most frequently during a defined period.

Accordingly, in the preferred embodiment the present invention consists of three major stages:
1. Gathering playback metrics for the user's digital media files
2. Analysing those playback metrics to determine the user's most played media files
3. Providing the user with non-time-limited versions of those digital media files

In the first stage, the client media player gathers playback metrics as to which digital media files the specific end user is playing on that device. The playback metrics are, in the preferred embodiment, sent to a remote server where all such playback metrics for all devices registered for the end user are consolidated for processing. In another example embodiment, playback metrics are processed on a per-device basis while other sample embodiments would perform the processing on the client device itself, transmitting the results of the processing to the remote server.

The second stage consists of processing the playback metrics, analysing them to determine the user's most played digital media files, whether on a per-device basis or, in the preferred embodiment, by aggregating all playback metrics across all of the user's registered devices.

The processing implements rules, which in the preferred embodiment are the result of negotiations with the Rights Holders of the digital media content, to determine the set of digital media files which are to be provided to the end user in stage three.

Typically, such rules would define the number of digital media files to be provided with a non-time-limited playback licence based on the number of plays of media files, the type of media files (audio, video, games, and so forth), the type of contract entered into by the end user (for example, Pay-As-You-Go or subscription contracts may utilise different rules), the length of the end user's subscription period and any other agreed factors.

For example, in one example embodiment pre-licensed subscribers would accumulate music tracks at a pro-rata rate equivalent of 100 tracks every 6 months, at a rate of 16 tracks per months with an extra 4 tracks in every sixth month, while Pay-As-You-Go users accumulate music tracks at the rate of 10 per month. In both cases, in this example embodiment of the rules, the specific tracks accumulated by the end user would be those which that user has played most (excluding any previously “earned tracks”) each month, and in the case of the end user not playing sufficient numbers of music tracks to allow enough to be accumulated (for distribution in stage 3) then additional tracks may be added based on overall playing metrics for all users on that subscription service.

Once stage two processing of the playback metrics has been performed, the resulting list of digital media files is then to be provided to the end user together with a non-time-limited playback license (that user's “earned tracks”, where “track” indicates any digital media file, including but not limited to music tracks, videos, news stories, features and computer games). The license may be an explicit DRM protection mechanism which is not time limited but which ties playback of the digital media files to a particular device or devices or it may be an implicit license in that previous DRM mechanisms applied to the digital media files are removed, permitting playback on any device.

In the preferred embodiment, any such earned tracks are calculated at the end of each month, processing to determine the list of earned tracks for that month excludes any tracks which have previously been earned by that user and uses criteria that identifies that user's n most played tracks during that month, where n is determined by the user's contract type.

At the end of the user's subscription, in the preferred embodiment, all earned tracks for that user will continue to play on the user's device by means of delivering an unlimited Rights Object for that track when the user selects that track outside of his subscription period. Where an earned track is no longer present on the device then, in the preferred embodiment, the user is permitted to download that track for playback, regardless of whether that user has a valid subscription at that time. In the preferred embodiment, this is facilitated on mobile devices by defining earned tracks as a separate “territory” domain on a handset, including handset and SIM identification. Handset may also, in the preferred embodiment, be disassociated from that domain in order to permit, for example, the end user to transfer his earned track licences to a different handset using a previously registered method of identification, such as a verified email address.

In addition, in the preferred embodiment end users are also provided with access to an online resource (the “Web locker”) from which they may download high quality MP3 files containing each of their earned music tracks, or equivalent unrestricted files for other forms of digital media, such as MP4 files encapsulating video or executables for video games. Such files may, in the preferred embodiment, be watermarked with the user's information, for tracking purposes.

The mechanism used to provision earned tracks in the preferred embodiment is via the provisioning of unlimited Rights Objects and by making unrestricted versions of the digital media files available to the user via the Web Locker.

In other example embodiments, different mechanisms for provisioning earned tracks to the end user may be employed. These might include:
Providing the user a with new file which isn't DRM protected, as per the Web Locker described in the preferred embodiment.
Giving the user access to a tool, or making use of a tool, to remove or modify the DRM protection on the DRM protected media file so as to make it time-unlimited. Specifically, that tool would be a software application which modifies or removes the DRM protection from a media file, resulting in one or more files. The tool may be executed by the user or may be executed automatically, whether locally or remotely, and the user provided with the resulting file or files. For example, the end user might upload their DRM protected file to a server where the protection is removed or modified and the user then downloads the resulting file.
The user is provided with a new Rights Object for their DRM protected media file. This is as described for the preferred embodiment's usage of unlimited Rights Objects.
The user is provided with a brand new media file, possibly DRM protected, along with a brand new DRM Rights Object for that new file, including the case where multiple media files are used to achieve a similar end.

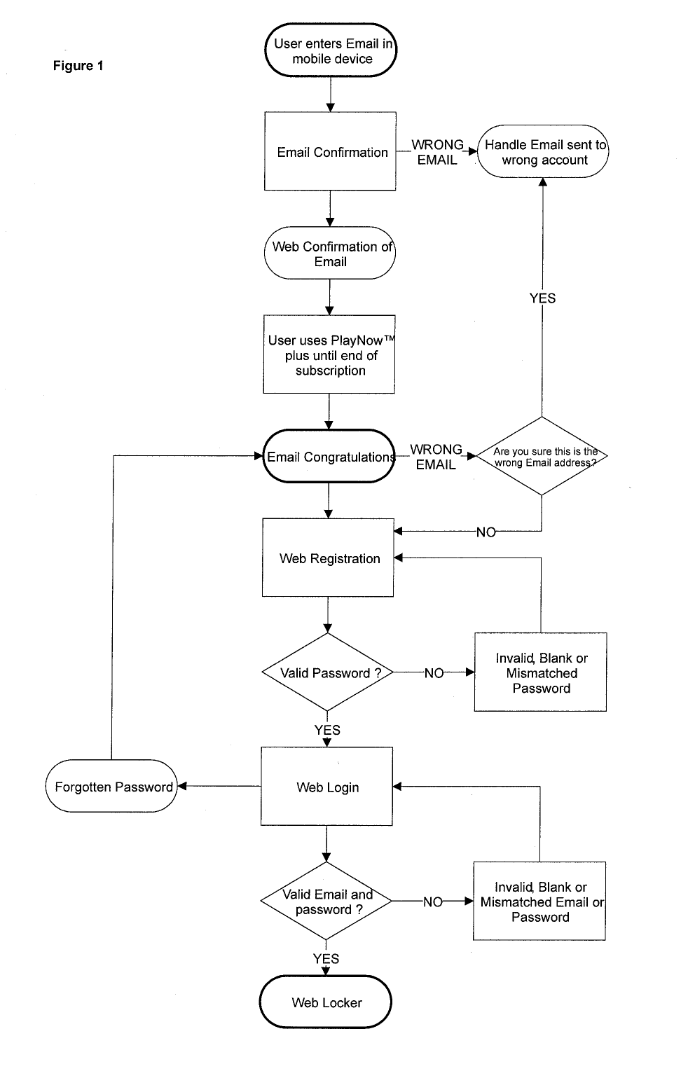

Referring now to the Figures, FIG. 1 shows the process logic for the Web Locker (see below). This illustrates the logical flow for the delivery of unrestricted digital media files, “earned tracks”, via an online facility where the user is identified using a verified email address.

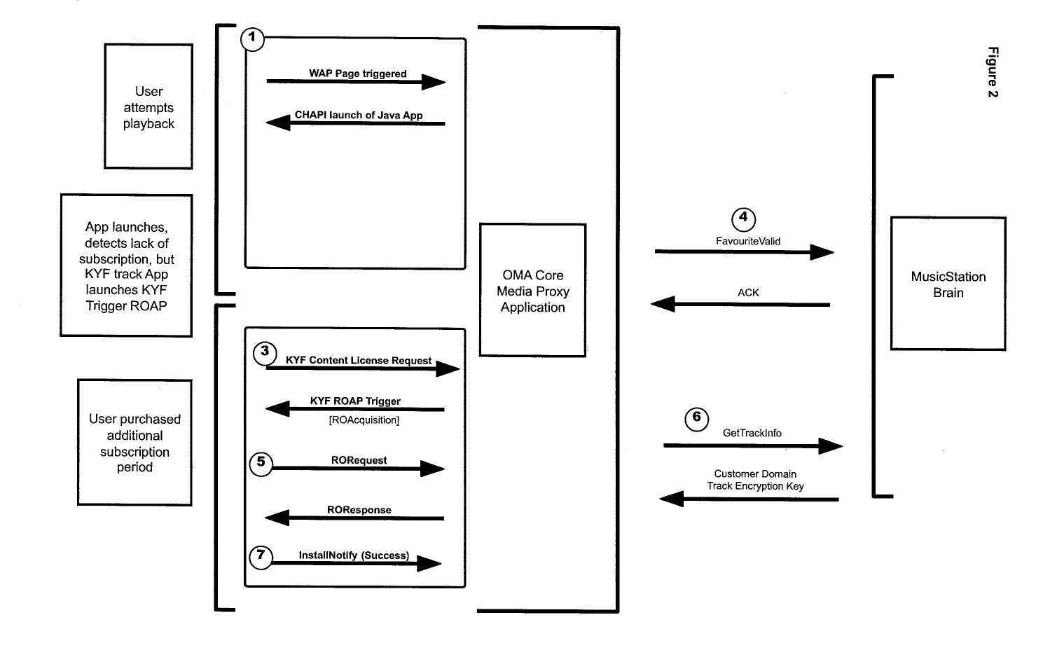

FIG. 2 shows the KYF (see below) Rights Object Delivery. This illustrates the process whereby a user attempts playback of an earned track (1) for which no Rights Object has previously been obtained, triggering a ROAP (Rights Object Acquisition Protocol) request (3) from the DRM server which, after checking (4) results in a request for (5) and the provision of an unlimited Rights Object to the device (6), on the receipt of which (7) the track may be played.

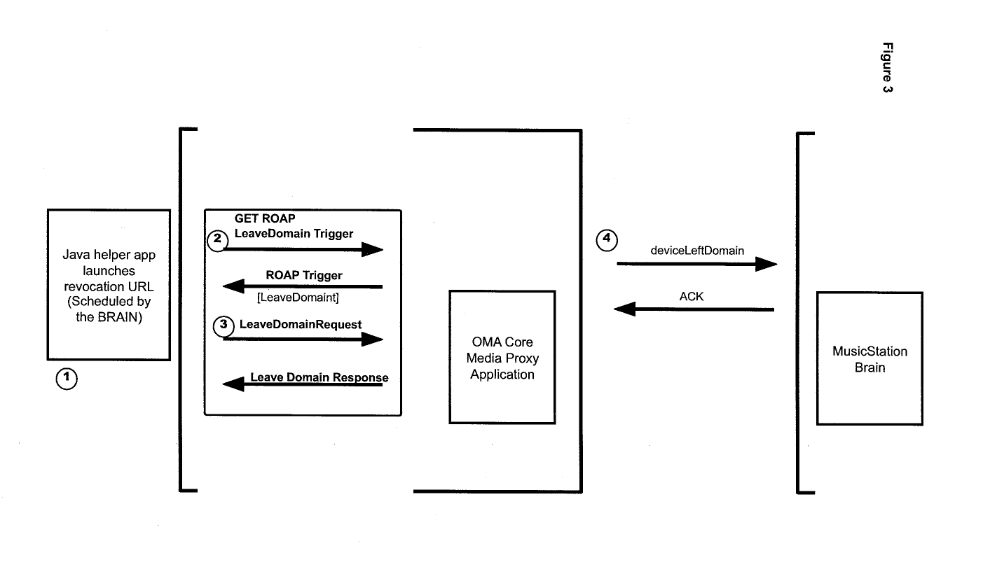

FIG. 3 illustrates the process of clearing previous Rights Objects from a device which has been de-registered (1) by the end user, resulting in a ROAP trigger (2) to clear the device (3) and confirm to the central server that the device has been disassociated (4) from the “earned tracks” domain. This may be done, for example, to permit the end user to transfer their earned tracks to a different device.

The following is a feature list of key features of the main implementation.
legally supplying one or more digitally encoded media files to one or more computing devices where the users of the device or devices are granted a license to play the media files without limitation of time
the digitally encoded media file can be protected by any DRM system
the digitally encoded media file can instead not be protected by any DRM system at all
the license can be granted for the digitally encoded media file by providing the user with access to a second media file which contains the same or substantially the same media content and which is not protected by any DRM system
the license can instead be granted for the digitally encoded media file by providing the user with access to a tool to modify any DRM protection from the digitally encoded media file, such as any time limitations for the Rights Object license for the media file or any other DRM protections; the tool removes any DRM protection from the digitally encoded media file and results in the production of one or more files in consequence of using the tool. The tool can also remove DRM protection from the digitally encoded media file, including but not limited to decrypting the media file, whether permanently or temporarily, and/or re-coding the decrypted media file to incorporate possibly-modified DRM protection for any DRM system, or no DRM protection. The tool can be a computing process (or any other means). The tool can be accessible only indirectly by the user, for example the tool can be applied to the digitally encoded media file on a remote server; the user is then given access to the resulting media file or files.
the license can be granted for the digitally encoded media file by providing the user with access to a Rights Object for a DRM system which provides access to the digitally encoded media file without limitation of time
the license can be granted for the digitally encoded media file by providing the user with access to (a) a second media file which contains the same or equivalent media content and which is protected by any DRM system and (b) a Rights Object for the DRM system or systems which provides access to the second media file without limitation of time. This second media file can consist of two or more media files, which in combination together describe the same or substantially the same media content of the original digitally encoded media file.
transfer of the non-time limited file or files to the device can be from a remote server or by any other method; the transfer can be performed via a wireless network, via the internet, via physical storage media or by any other method. The transfer can happen automatically at any time
the license can be provided on or after a specified date; the date can be defined using a single or recurrent interval starting from a fixed date or any other equivalent triggering mechanism, such as the starting date of a subscription, the expiration of a subscription or any other specified date. The date can be a combination of a date and a time.
the non time limited media files can be associated with the user or with the user's computing device using digital watermarking or by any other method.
some but not all DRM protection can be removed from the non-time limited versions; for example, it is possible to retain a restriction that the media file may be played only on a specific computing devices or device.

In another approach, the system does not actually gather playback metrics at all. Instead, the user simply manually chooses the particular media files he or she wishes to keep; so for example, each month, the user could be given 10 ‘credits’ and hence be able to select 10 music tracks each month. These will then be made available (using the same mechanisms described above) to the user as non-time limited versions. The user can select these from any of the possibly thousands of files on his or her device. In a typical scenario, some limited DRM-based controls will still be applied to the non-time limited versions/music tracks, such as allowing the track to be burnt to CD up to a defined number of times (e.g. five times). But the chosen tracks can still be played an unlimited number of times after the subscription has expired and can be synchronised an unlimited number of times with an unlimited number of players. A variant of this is where the device presents a shortlist of the most played tracks and the user then manually chooses the tracks to be kept permanently.

Appendix 1—Metering and Reporting

In the main implementation, digital media files are made available from a main production database for multiple consumer devices from a computer-based infrastructure. The consumer devices then meter the number of playbacks of a media file that last beyond a predefined extent, in order to generate metering data. The consumer devices then automatically report that metering data back to the computer-based infrastructure. All track plays/listens are reported from the consumer's device back to the server for optimisation of the engine and the overall infrastructure. In addition the metering data can be used:
to identify tracks which are not present on a digital media service for a given locale;
to identify tracks for further processing, such as identifying a need for the ingestion of additional or updated metadata for a one or more tracks; or provisioning one or more tracks to a user using a different digital media file format. The different digital media file format may utilises a form of DRM protection, or no DRM protection.
to recommend further media content to a specific user, where the metrics gathered about that user's media playing preferences are used to assist with calculations as to the user's likely preferences for watching, reading or listening to digital media content in the future.

In Addition:
In the preferred embodiment, Metering is implemented differently on different devices and reported with different regularity based on connectedness.
Metering data for a consumer with more than one type of device (e.g. phone and PC) needs, in a typical example embodiment, to be created, collected and consolidated even though it comes from different platforms with different rules and formats.

In an example embodiment, the system supports the creation, collection, consolidation and administration of content usage metering files across multiple platforms and reporting facilities including, but not limited to calculating and reporting the complex financial and usage statistics to the plethora of stakeholders requiring reports in multiple territories. Stakeholders requiring reports include major music labels, independent music labels, content aggregators, publishing societies and business partners. In the preferred embodiment, the reporting analysis also provides highly sophisticated analysis such as churn analysis and subscriber behaviour reporting.

The core metering action in this system is the recording of a track play, or the playing of some other digital media file, such as a movie, a game, an article or a news story. For convenience, all such digital media content will be referred to herein as “tracks”, with defined collections of “tracks” being referred to as “albums” or “releases.”

The system identifies a track as having been played on a client device when some minimum portion of that track has been played, the minimum portion being configurable based on media type but in the case of music files would typically be either 4%-5% of the track length or 30 seconds. Track plays below the defined threshold would not be recorded for metrics or reporting purposes, since such brief plays may be generated by user's skipping past tracks.

The context of a track play is also recorded in the metrics. Contextual information includes, in an example embodiment, the album/release, playlist, chart or other context from which the played track originated as well as basic information including, but not limited to, one or more of: the client device on which the track was played, the user who played that track, the duration/proportion of the track which was in fact played and the internal session context of the track play, such as the tracks played immediately prior to or after that track.

Metering information (“metrics”) is gathered on the client device and is communicated to the server. The frequency and method of transport of metrics to the server is dependent on the type of device but, in the preferred embodiment, typical scenarios would include:
An always-connected high-bandwidth device, such as PC which is online, would typically send metrics to the server as soon as possible.
An intermittently-connected or low-bandwidth device, such as a mobile handset or a roaming in-car music system, would typically send metrics to the server at predefined intervals and/or according to specific triggers, such as “as soon as the client device detects that sufficient bandwidth is available.”

The method of transportation, in the preferred embodiment, is to piggyback the metrics on an existing communication which the client device would have had to send to the server in any event, such as a request for recommendations or for a media file or a polling event asking the server for messages to be delivered to the client device's inbox. Another example embodiment may send specific messages to deliver metrics, and that approach may be taken in the preferred embodiment if the client device has metrics but no other requests queued for sending to the server in excess of some configurable period of time (typically 60 minutes).

Metrics received by the server are, in the preferred embodiment, stored in auditing database tables. Such metrics may also be enriched with one or more items of additional metadata, including the genre, artist, era, music publisher, copyright holder, demographic information about the user, downloaded or streamed file sizes, bandwidth available to a client device at the time and any additional information about which reporting analyses are desired. In the preferred embodiment, metrics stored for reporting purposes are anonymised in order to protect the user's privacy.

A second major area for which metrics are recorded is that of user subscriptions and purchasing. Specifically, the system provides a mechanism whereby it is recorded when a user performs one or more of the following actions: signing up to a subscription service, purchasing one or more digital media files, modifying or cancelling a subscription or playing a preview of a track. All such requests made to the server are stored, suitably anonymised in the preferred embodiment, in the audit database tables for subsequent report generation.

The auditing database tables may then be used to generate reports, both internally and for third parties such as music labels or movie studios.

Typical reports generated by the present invention in its preferred embodiment include:
Subscriber churn reports, indicating the number of users who have signed up to or cancelled a subscription to a digital media service in a defined time period
Financial reports, indicating the royalties payable to a given media publisher for a specified period, based on track plays for a subscription service and/or track purchases for any digital media service
Realtime reports, indicating the activities being undertaken on a specific service at any given moment in time
Trend reports, indicating trends in, for example, music listening or movie watching preferences of users of a digital media service over time
Chart reports, indicating the most popular (by, for example, track plays, purchases or user- or critic-generated ratings) digital media files.
Subscriber usage reports, indicating the usage of a service by subscribers over time. For example, this may include details such as the number or size of tracks downloaded on a particular service
Community activity reports, indicating the volume of messages, recommendations and any other communications send via a “community” aspect of a digital media service

Reports may also, in the preferred embodiment, capable of being broken down by one or more of the following classifications: genre, adult content status, era, publication or other dates, artist, publisher, copyright holder, time period, chart rankings, director, writer/composer, client device type, digital media service or any other stored metadata.

Numeric details may be presentable as overall figures, averages, medians, some other statistical measure or a combination thereof. The reporting period, the format of generated reports and the frequency with which they are generated is also, in the preferred embodiment, configurable.

Report formats may be updated frequently, typically used for realtime reports which may update at intervals defined in seconds or fractions thereof, or generated as documents intended for viewing on a computer or for printing.

1. A method of providing digital media content to computing devices, including the steps:
(a) gathering playback metrics for a user's DRM-protected digital media files;
(b) analysing those playback metrics to determine a user's favourite media files; and
(c) providing the user with non-time limited versions of those favourite digital media files.

2. The method of claim 1 in which the playback metrics measure the following to enable the selection of the non-time limited versions: how many times digital media content files are played back for more than a predefined threshold.

3. The method of claim 1 in which the playback metrics measure the following to enable the selection of the non-time limited versions: how often digital media content files are played back for more than a predefined threshold.

4. The method of claim 1 in which the user can choose the desired non-time limited versions from a list automatically generated by analysing the playback metrics.

5. The method of claim 1 in which the playback metrics detect specific flags or notifications a user has applied to indicate that a track is a favourite track and a non-time limited version of that track should be made available.

6. The method of claim 1 in which the non-time limited versions are selected entirely automatically.

7. The method of claim 1 in which the playback metrics are analysed at a remote server.

8. The method of claim 1 in which playback metrics are analysed at the device.

9. The method of claim 1 in which analysing the playback metrics can be done in different, customisable ways.

10. The method of claim 1 in which the playback metrics that are analysed relate to a single computing device that is used by the user.

11. The method of claim 1 in which the playback metrics that are analysed relate to multiple computing devices that are used by the user.

12. The method of claim 11 in which the playback metrics for multiple computing devices are aggregated together.

13. The method of claim 11 in which the multiple computing devices include two or more of the following: mobile telephone; PC, MP3 player, mobile device, in-car stereo, television set, web browser.

14. The method of claim 1 in which non-time-limited versions are tied to one or more specific playback devices.

15. The method of claim 1 in which non-time-limited versions can be used on any playback device.

16. The method of claim 1 in which non-time limited versions are obtained by altering the DRM-protected digital media files already resident on the device.

17. The method of claim 16 in which altering the DRM-protected digital media files already resident on the device is done by the user accessing a tool that removes or modifies the DRM protection applied to the media file to make it non time-limited.

18. The method of claim 1 in which the non-time limited versions are different files to the corresponding DRM protected files.

19. The method of claim 18 in which the non-time limited versions are accessed from a web-based locker.

20. The method of claim 1 in which non-time limited versions are DRM-protected but associated with a long term access rights object.

21. The method of claim 1 in which non-time limited versions are not DRM-protected.

22. The method of claim 1 in which the DRM-protected media files are supplied as part of an unlimited download music subscription service.

23. The method of claim 1 in which the DRM-protected digital media files are provided under subscription and when the subscription ends the non-time limited versions can still be obtained and played back.

24. The method of claim 1 in which media content is music tracks, video games, text, images, videos or some combination thereof.

25. The method of claim 1 in which a fixed number of non-time limited versions are provided for each month of a DRM-based subscription service.

26. The method of claim 25 in which a fixed number of non-time limited music tracks are provided for each month of a DRM-based subscription service.

27. A system for providing digital media content to computing devices, including
a computer-based system for:
(a) gathering playback metrics for a user's DRM-protected digital media files;
(b) analysing those playback metrics to determine a user's favourite media files; and
(c) providing the user with non-time limited versions of those favourite digital media files.
